(19) United States
(12) Patent Application Publication
(10) Pub. No.: US 2020/0060097 A1
(43) Pub. Date: Feb. 27, 2020

(54) SYSTEMS AND METHODS FOR MANAGING PLANT GROWTH WITHIN AN ASSEMBLY LINE GROW POD

(71) Applicant: Grow Solutions Tech LLC, Vineyard, UT (US)

(72) Inventor: Gary Bret Millar, Highland, UT (US)

(73) Assignee: Grow Solutions Tech LLC, Vineyard, UT (US)

(21) Appl. No.: 16/529,034

(22) Filed: Aug. 1, 2019

Related U.S. Application Data
(60) Provisional application No. 62/713,027, filed on Aug. 1, 2018.

(51) Int. Cl. A01G 7/04; A01G 31/04; A01G 9/24; A01G 9/02; A01G 9/26

(52) U.S. Cl. CPC A01G 7/045; A01G 31/04; A01G 9/26; A01G 9/02; A01G 9/249

(57) ABSTRACT

A lighting system for an assembly line grow pod includes a fixture, an actuator coupled to the fixture, one or more electromagnetic sources positioned at least partially within the fixture, a distance sensor, and a controller communicatively coupled to the actuator and the distance sensor, the controller including a processor and a computer readable and executable instruction set, which when executed, causes the processor to receive a signal from the distance sensor indicative of a detected distance between the distance sensor and plant matter positioned below the one or more electromagnetic sources, determine whether the detected distance is less than a configurable threshold, and in response to determining that the detected distance is less than the configurable threshold, direct the actuator to move the fixture upward in a vertical direction.

### CROSS-REFERENCE TO RELATED APPLICATIONS

This application claims the benefit of U.S. Provisional Patent Application Ser. No. 62/713,027 entitled “Systems and Methods for Managing Plant Growth Within an Assembly Line Grow Pod” and filed Aug. 1, 2018, the entirety of which is hereby incorporated by reference.

### TECHNICAL FIELD

Embodiments described herein generally relate to systems and methods for managing plant growth within an assembly line grow pod, and more particularly to artificial lighting systems that manage plant growth within an assembly line grow pod.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the United States currently has suitable farmland to adequately provide food for the U.S. population, other countries and future populations may not have enough farmland to provide the appropriate amount of food.

Controlled environment growing systems may mitigate the factors affecting a harvest. In these controlled environment growing systems, artificial lighting systems may be utilized to support photosynthesis. As plant matter grows within the controlled environment growing system, a height of the plant matter may increase, thereby changing a distance between the plant matter and the artificial lighting system. As the distance between the plant matter and the artificial lighting system decreases, the intensity of light provided to the plant matter may change, which may affect the growth of the plant matter.

### SUMMARY

In one embodiment, a lighting system for an assembly line grow pod includes a fixture, an actuator coupled to the fixture, one or more electromagnetic sources positioned at least partially within the fixture, a distance sensor, and a controller communicatively coupled to the actuator and the distance sensor, the controller including a processor and a computer readable and executable instruction set, which when executed, causes the processor to receive a signal from the distance sensor indicative of a detected distance between the distance sensor and plant matter positioned below the one or more electromagnetic sources, determine whether the detected distance is less than a configurable threshold, and in response to determining that the detected distance is less than the configurable threshold, direct the actuator to move the fixture upward in a vertical direction.

In another embodiment, a method for managing plant growth within an assembly line grow pod includes detecting at least one of a distance between one or more electromagnetic sources and plant matter positioned below the one or more electromagnetic sources, and an amount of photons received at the plant matter, and moving the one or more electromagnetic sources in a vertical direction with respect to the plant matter based at least in part on at least one of the detected distance between the one or more electromagnetic sources and the plant matter and the detected amount of photons received at the plant matter.

In yet another embodiment, an assembly line grow pod includes a cart engaged with a track, a fixture positioned above the track in a vertical direction, an actuator coupled to the fixture, one or more electromagnetic sources positioned at least partially within the fixture, at least one of a distance sensor and a photo detector, and a controller communicatively coupled to the actuator and the at least one of the distance sensor and the photo detector, the controller including a processor and a computer readable and executable instruction set, which when executed, causes the processor to receive a signal from at least one of the distance sensor indicative of a detected distance between the one or more electromagnetic sources and plant matter positioned in the cart, and the photo detector indicative of a detected amount of photons received by the plant matter positioned within the cart, and direct the actuator to move the fixture in the vertical direction with respect to the cart based at least in part on at least one of the detected distance between the one or more electromagnetic sources and the plant matter and the detected amount of photons received at the plant matter.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an assembly line grow pod, according to one or more embodiments shown and described herein;

FIG. 2 schematically depicts a cart and a lighting system of the assembly line grow pod of FIG. 1, according to one or more embodiments shown and described herein;

FIG. 3 schematically depicts an illustrative computing environment of the assembly line grow pod of FIG. 1, according to one or more embodiments shown and described herein;

FIG. 4A schematically depicts the cart and the lighting system of the assembly line grow pod of FIG. 1 with plant matter at an initial stage of growth, according to one or more embodiments shown and described herein;

FIG. 4B schematically depicts the cart and the lighting system of the assembly line grow pod of FIG. 1 with plant matter at a progressed stage of growth, according to one or more embodiments shown and described herein;

FIG. 4C schematically depicts the cart and the lighting system of the assembly line grow pod of FIG. 1 with plant matter at a further progressed stage of growth, according to one or more embodiments shown and described herein;

FIG. 5 schematically depicts a flow diagram of an illustrative method for moving a movable fixture of the lighting system of FIG. 2, according to one or more embodiments shown and described herein; and

FIG. 6 schematically depicts a flow diagram of another illustrative method for moving a movable fixture of the lighting system of FIG. 2, according to one or more embodiments shown and described herein.

### DETAILED DESCRIPTION

Embodiments disclosed herein are directed to assembly line grow pods including a lighting system. In embodiments, the lighting system includes one or more electromagnetic sources positioned within a movable fixture. In some embodiments, the movable fixture is movable in the vertical direction to adjust the amount of photons received by plant matter positioned below the one or more electromagnetic sources. In some embodiments, the movable fixture is movable in the vertical direction such that the one or more electromagnetic sources may be kept at a constant or nearly constant distance above plant matter positioned within a cart underneath the lighting system. By keeping the one or more electromagnetic sources at a constant or nearly constant distance above the plant matter, a consistent intensity of electromagnetic energy may be provided to the plant matter, which may assist in facilitating growth of the plant matter. Assembly line grow pods including a lighting system will be described in more detail below with reference to the appended drawings.

As used herein, the term “plant matter” may encompass any type of plant and/or seed material at any stage of growth, for example and without limitation, seeds, germinating seeds, vegetative plants, and plants at a reproductive stage.

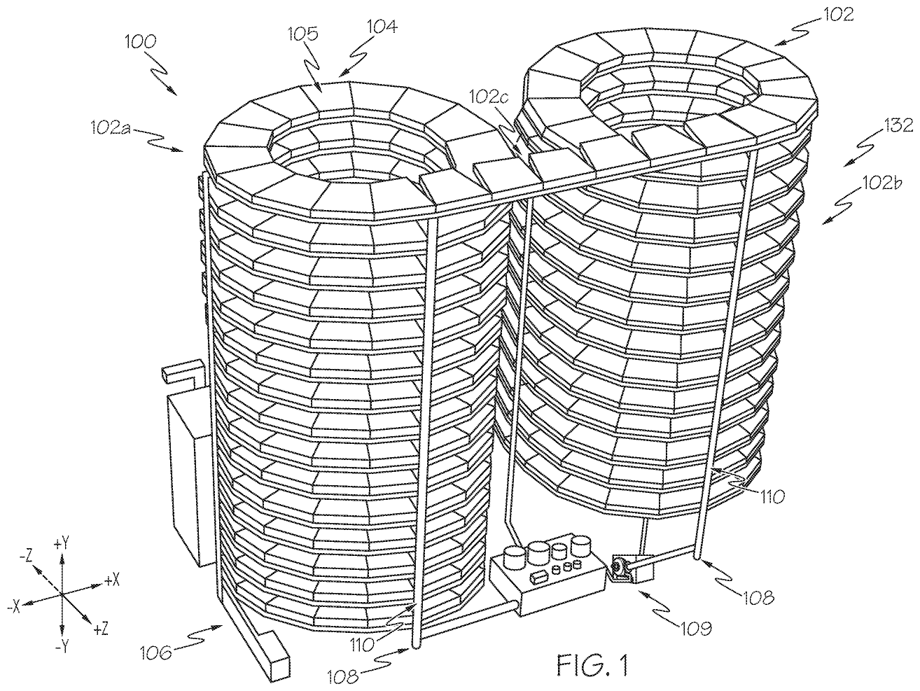

Referring initially to FIG. 1, a front perspective view of an assembly line grow pod 100 is depicted. The assembly line grow pod 100 includes a track 102 that is configured to allow one or more carts 104 to travel along the track 102. In the embodiment depicted in FIG. 1, the assembly line grow pod 100 includes an ascending portion 102a, a descending portion 102b, and a connection portion 102c. The track 102 at the ascending portion 102a moves upward in a vertical direction (e.g., in the +y-direction as depicted), such that carts 104 moving along the track 102 move upward in the vertical direction as they travel along the ascending portion 102a. The track 102 at the ascending portion 102a may include curvature as depicted in FIG. 1, and may wrap around a first axis that is generally parallel to the y-axis depicted in the coordinate axes of FIG. 1, forming a spiral shape around the first axis.

The connection portion 102c is positioned between the ascending portion 102a and the descending portion 102b, and may be relatively level as compared to the ascending portion 102a and the descending portion 102b, such that the track 102 generally does not move upward or downward in the vertical direction at the connection portion 102c. The track 102 at the descending portion 102b moves downward in the vertical direction (e.g., in the −y-direction as depicted), such that carts 104 moving along the track 102 move downward in the vertical direction as they travel along descending portion 102b. The track 102 at the descending portion 102b may be curved, and may wrap around a second axis that is generally parallel to the y-axis depicted in the coordinate axes of FIG. 1, forming a spiral shape around the second axis.

In some embodiments, such as the embodiment shown in FIG. 1, the ascending portion 102a and the descending portion 102b may generally form symmetric shapes and may be mirror-images of one another. In embodiments in which the ascending portion 102a and the descending portion 102b each form spiral shapes, portions of the track 102 may be positioned over one another in the vertical direction (e.g., in the +/−y-direction as depicted), forming ascending and descending “levels” of the track 102. In some embodiments, the ascending portion 102a and the descending portion 102b may include different shapes (such as ovals and/or other regular or non-regular shapes) that ascend and descend in the vertical direction, respectively. The ascending portion 102a and the descending portion 102b may allow the track 102 to extend a relatively long distance while occupying a comparatively small footprint evaluated in the x-direction and the z-direction as depicted in the coordinate axes of FIG. 1, as compared to assembly line grow pods that do not include an ascending portion 102a and a descending portion 102b. Minimizing the footprint of the assembly line grow pod 100 may be advantageous in certain applications, such as when the assembly line grow pod 100 is positioned in a crowded urban center or in other locations in which space is limited.

In the embodiment depicted in FIG. 1, the carts 104 of the assembly line grow pod 100 include trays 105 for holding plant matter. In operation, the trays 105 of the carts 104 are loaded with plant matter, such as through a seeding process. The plant matter is then grown within the carts 104 as the carts 104 move along the track 102 in a growing region 132 of the assembly line grow pod 100. For example, after plant matter is deposited within the carts 104, the carts 104 move up the track 102 on the ascending portion 102a, across the connection portion 102c, and down the track 102 on the descending portion 102b. As the carts 104 move along the track 102, the plant matter within the trays 105 of the carts 104 may grow and develop. After moving down the track 102 at the descending portion 102b, the plant matter within the carts 104 may be harvested. In some instances, the plant matter within the carts 104 may not be ready for harvest after moving down the descending portion 102b. In these instances, the carts 104 may proceed to take another lap up the track 102 of the ascending portion 102a, across the connection portion 102c, and down the track 102 of the descending portion 102b.

In the embodiment depicted in FIG. 1, the assembly line grow pod 100 includes one or more water lines 110 extending up the ascending portion 102a and the descending portion 102b (e.g., generally in the +/−y-direction as depicted) to distribute water and nutrients to plant matter within carts 104 on the track 102. In embodiments, the one or more water lines 110 distribute water and/or nutrients to carts 104 at predetermined areas of the growing region 132 of the assembly line grow pod 100. The one or more water lines 110 may be coupled to a pump 109 and one or more valves 108 that selectively direct water and/or nutrients through the one or more water lines 110.

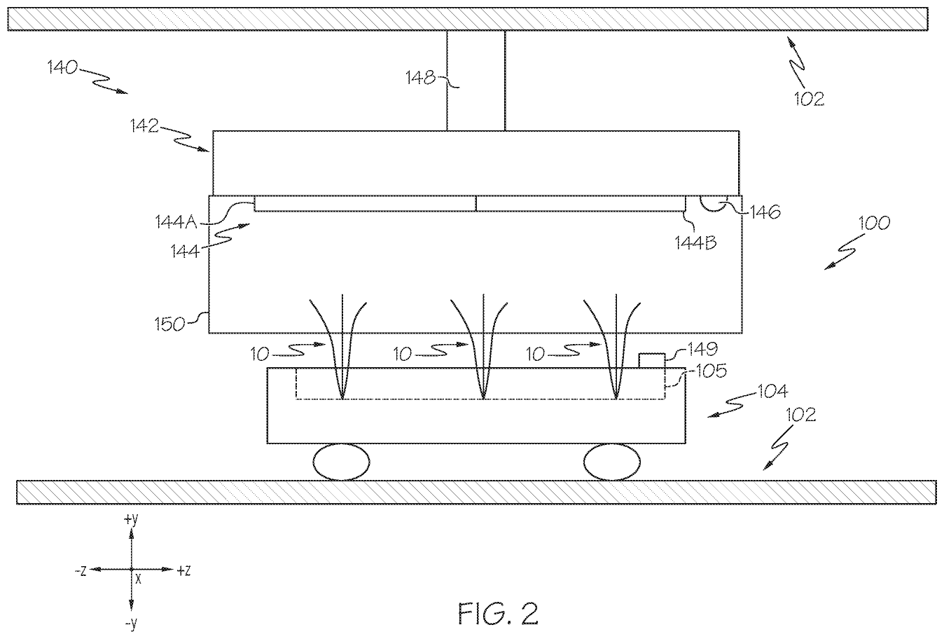

Referring to FIG. 2, a side view of one of the carts 104 on the track 102 is schematically depicted. The assembly line grow pod 100 generally includes a lighting system 140 that provides electromagnetic radiation (e.g., photons) to plant matter 10 positioned within trays 105 of the carts 104 on the assembly line grow pod 100. The lighting system 140 generally includes a movable fixture 142, an actuator 148 coupled to the movable fixture 142, one or more electromagnetic sources 144, and a distance sensor 146. As noted above, the track 102 of the assembly line grow pod 100 may wrap around an axis at the ascending portion 102a and the descending portion 102b, such that the track 102 forms different “levels” positioned over one another in the vertical direction. In embodiments, the lighting system 140 may generally be coupled to an underside of one “level” (e.g., a second level) of the track 102 and may be positioned over a lower “level” (e.g., a first level) of the track 102 in the vertical direction (e.g., in the y-direction as depicted). In particular, the actuator 148 of the lighting system 140 is coupled to the underside of the track 102 and is structurally configured to move the movable fixture 142 upward and downward in the vertical direction (e.g., in the +/−y-direction as depicted). In some embodiments, such as embodiments that do not include an ascending portion 102a and/or a descending portion 102b, the lighting system 140 may be coupled to a ceiling or other structure positioned above the track 102 in the vertical direction.

In some embodiments, the actuator 148 may also be movable in a longitudinal direction (e.g., in the +/−z-direction as depicted) such that the actuator 148 may move the movable fixture 142 in the longitudinal direction. The cart 104 moves along the track 102 and may generally move along the track 102 in the longitudinal direction (e.g., in the +z-direction as depicted). By moving the movable fixture 142 in the longitudinal direction, the actuator 148 may allow the movable fixture 142 to “follow” the cart 104 as the cart 104 moves in the longitudinal direction. In some embodiments, the movable fixture 142 may follow the cart 104 throughout the assembly line grow pod 100 for the entire grow cycle (e.g., up the ascending portion 102a (FIG. 1) and down the descending portion 102b (FIG. 1)). In other embodiments, the movable fixture 142 may follow the cart 104 a predetermined distance along the track 102, and the cart 104 may subsequently be positioned beneath another movable fixture 142.

In some embodiments, the actuator 148 and the movable fixture 142 are movable in the lateral direction (e.g., in the +/−x-direction as depicted). In these embodiments, the movable fixture 142 may be selectively biased to one side of the cart 104 or the other. In still other embodiments, the actuator 148 and the movable fixture 142 may be generally fixed with respect to the track 102 in the longitudinal direction (e.g., in the +/−z-direction as depicted) and/or the lateral direction (e.g., in the +/−x-direction as depicted), and the actuator 148 may move the movable fixture 142 solely in the vertical direction (e.g., in the +/−y-direction as depicted).

In embodiments, the actuator 148 may include any suitable mechanism for moving the movable fixture 142 in the vertical direction and/or the longitudinal direction. For example and without limitation, the actuator 148 may include a direct current (DC) motor, an alternating current (AC) motor, a pneumatic device, a hydraulic device, or the like.

The one or more electromagnetic sources 144 are positioned at least partially within the movable fixture 142 and are structurally configured to emit electromagnetic radiation to the track 102 positioned below the lighting system 140. For example, the one or more electromagnetic sources 144 may include, for example and without limitation, light emitting diodes (LEDs), incandescent lamps, halogen lamps, fluorescent tubes, neon lamps, high intensity discharge lamps, halogen lamps, or the like. In embodiments, the one or more electromagnetic sources 144 may emit comparatively little thermal energy such that proximity of the one or more electromagnetic sources 144 to the plant matter 10 generally does not damage the plant matter 10. The one or more electromagnetic sources 144 generally provide lighting (e.g., photons) to the plant matter 10 positioned in the cart 104 below the one or more electromagnetic sources 144 to support photosynthesis in the plant matter 10. In some embodiments, the one or more electromagnetic sources 144 may be configured to output a variable intensity of electromagnetic energy and/or variable wavelengths of electromagnetic energy. For example, the one or more electromagnetic sources 144 may be configured to output different wavelengths of light to different types of plant matter 10 positioned within the cart 104 and/or to output different wavelengths of light at different stages of growth of the plant matter 10. Similarly, the one or more electromagnetic sources 144 may be configured to output different intensities of electromagnetic energy. For example, the one or more electromagnetic sources 144 may be configured to output different intensities of electromagnetic energy to different types of plant matter 10 and/or to output different intensities of electromagnetic energy at different stages of growth of the plant matter 10.

In some embodiments, the one or more electromagnetic sources 144 may include a first electromagnetic source 144A and a second electromagnetic source 144B that is separate from the first electromagnetic source 144A. In some embodiments, the first electromagnetic source 144A and the second electromagnetic source 144B may be utilized to emit different wavelengths and/or different intensities of electromagnetic energy to different portions of the cart 104. For example, the first electromagnetic source 144A may output a first wavelength and/or a first intensity of electromagnetic energy, while the second electromagnetic source 144B may output a second wavelength and/or a second intensity of electromagnetic energy, where the first wavelength is different from the second wavelength and the first intensity is different from the second intensity. In this way, the lighting system 140 may simultaneously apply different wavelengths and/or different intensities of electromagnetic energy to different portions of the cart 104 positioned below the lighting system 140. While in the embodiment depicted in FIG. 2 the lighting system 140 includes a first electromagnetic source 144A and a second electromagnetic source 144B positioned forward of the first electromagnetic source 144A, it should be understood that the lighting system 140 may include any suitable number of electromagnetic sources positioned in any suitable arrangement. Moreover, it should be understood that each of the electromagnetic sources may be capable emitting variable wavelengths and/or variable intensities of electromagnetic energy, and may be capable of emitting different wavelengths and different intensities of electromagnetic energy from one another.

The lighting system 140 also includes the distance sensor 146. The distance sensor 146 is structurally configured to detect a distance between the distance sensor 146 and objects positioned beneath the distance sensor 146 in the vertical direction (e.g., in the y-direction as depicted). In particular, the distance sensor 146 may detect a distance between the distance sensor 146 and the plant matter 10 within the cart 104. In the embodiment depicted in FIG. 2, the distance sensor 146 is coupled to the movable fixture 142, and may move up and down in the vertical direction (e.g., in the +/−y-direction as depicted) along with the movable fixture 142. In other embodiments, the distance sensor 146 may be coupled to the underside of the track 102 and may generally remain in a fixed position in the vertical direction (e.g., in the +/−y-direction as depicted). In embodiments, the distance sensor 146 may include any suitable device for detecting a distance, for example and without limitation, a laser sensor, a radio detection and ranging (RADAR) sensor, a light detection and ranging (LIDAR) sensor, or the like. Based on a detected distance between the distance sensor 146 and the plant matter 10 within the cart 104, the actuator 148 may move the movable fixture 142 in the vertical direction, as described in greater detail herein.

In some embodiments, the lighting system 140 optionally includes a shroud 150 extending downward from the movable fixture 142. The shroud 150 may generally extend around a perimeter of the movable fixture 142 and may assist in focusing electromagnetic energy from the one or more electromagnetic sources 144 onto the plant matter 10 positioned within the cart 104. In some embodiments, the shroud 150 may be formed from a material that reflects electromagnetic energy, which may assist in focusing electromagnetic energy on the plant matter 10 within the cart 104.

In some embodiments, the lighting system 140 further includes a photo detector 149. The photo detector 149 is structurally configured to detect an amount of electromagnetic energy (e.g., photons) received at a position below the one or more electromagnetic sources 144. In the embodiment depicted in FIG. 2, the photo detector 149 is positioned within the cart 104 and is structurally configured to detect an amount of electromagnetic energy (e.g., photons) received at the cart 104. By positioning the photo detector 149 within the cart 104, the photo detector 149 may detect the amount of electromagnetic energy received at positions proximate to the plant matter 10, thereby detecting an amount of electromagnetic energy (e.g., photons) that is generally representative of the amount of electromagnetic energy received by the plant matter 10. In some embodiments, the photo detector 149 may be positioned at locations other than the cart 104, for example, at locations on the track 102.

Referring collectively to FIGS. 1 and 2, the assembly line grow pod 100 includes a master controller 106. The master controller 106 may include various components that control particular portions of the assembly line grow pod 100. For example, the master controller 106 may contain components for controlling various environmental conditions within the assembly line grow pod 100, such as light, temperature, humidity, and/or the like.

For example, the master controller 106 is communicatively coupled to the actuator 148, the one or more electromagnetic sources 144, the photo detector 149, and/or the distance sensor 146, and may send and/or receive signals to the actuator 148, the one or more electromagnetic sources 144, the photo detector 149, and/or the distance sensor 146. In one embodiment, the master controller 106 may send signals to the actuator 148 directing the actuator 148 to move the movable fixture 142 upward or downward in the vertical direction (e.g., in the +/−y-direction as depicted). The master controller 106 may also receive signals from the distance sensor 146 indicative of a detected distance between the distance sensor 146 and the plant matter 10 positioned within the cart 104. In embodiments, the master controller 106 may also receive signals from the photo detector 149 indicative of an amount of photons received at the plant matter 10 positioned below the one or more electromagnetic sources 144.

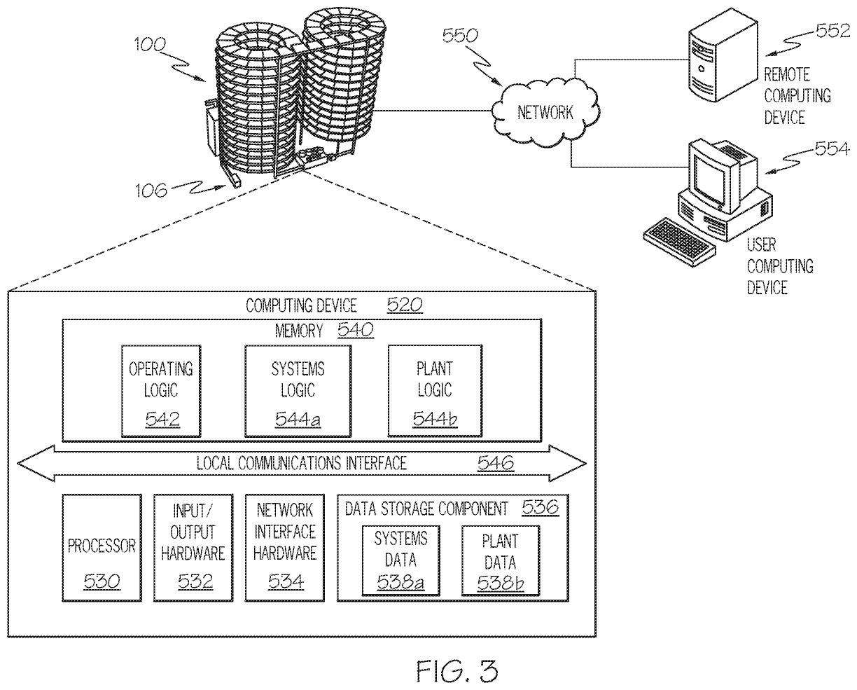

Referring now to FIG. 3, the master controller 106 may include a computing device 520. The computing device 520 includes a processor 530, input/output hardware 532, the network interface hardware 534, a data storage component 536 (which stores systems data 538a, plant data 538b, and/or other data), and the memory component 540. The memory component 540 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the computing device 520 and/or external to the computing device 520.

The memory component 540 may store operating logic 542, the systems logic 544a, and the plant logic 544b. The systems logic 544a and the plant logic 544b may each include a plurality of different pieces of logic, each of which may be embodied as a computer program, firmware, and/or hardware, as an example. The systems logic 544a may monitor and control operations of one or more of the actuator 148 (FIG. 2), the one or more electromagnetic sources 144 (FIG. 2), the photo detector 149 (FIG. 2) and/or the distance sensor 146 (FIG. 2). The plant logic 544b may be configured to determine and/or receive a recipe for plant growth, including a desired light intensity to be provided to plant matter positioned within the carts 104 (FIG. 2) and may facilitate implementation of a recipe to plant matter positioned within the carts 104 (FIG. 2) via the systems logic 544a.

The operating logic 542 may include an operating system and/or other software for managing components of the computing device 520. As also discussed above, systems logic 544a and the plant logic 544b may reside in the memory component 540 and may be configured to perform the functionality, as described herein.

It should be understood that while the components in FIG. 3 are illustrated as residing within the computing device 520, this is merely an example. In some embodiments, one or more of the components may reside external to the computing device 520. It should also be understood that, while the computing device 520 is illustrated as a single device, this is also merely an example. In some embodiments, the systems logic 544a and the plant logic 544b may reside on different computing devices. As an example, one or more of the functionalities and/or components described herein may be provided by a user computing device and/or a remote computing device.

Additionally, while the computing device 520 is illustrated with the systems logic 544a and the plant logic 544b as separate logical components, this is also an example. In some embodiments, a single piece of logic (and/or or several linked modules) may cause the computing device 520 to provide the described functionality.

A local interface 546 is also included in FIG. 3 and may be implemented as a bus or other communication interface to facilitate communication among the components of the computing device 520. The processor 530 may include any processing component operable to receive and execute instructions (such as from a data storage component 536 and/or the memory component 540). The input/output hardware 532 may include and/or be configured to interface with microphones, speakers, a display, and/or other hardware.

The network interface hardware 534 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the computing device 520 and other devices external to the computing device.

Additionally, the assembly line grow pod 100 is coupled to a network 550. The network 550 may include the internet or other wide area network, a local network, such as a local area network, a near field network, such as Bluetooth or a near field communication (NFC) network. The network 550 is also coupled to a user computing device 554 and/or a remote computing device 552. The user computing device 554 may include a personal computer, laptop, mobile device, tablet, server, etc. and may be utilized as an interface with a user. As an example, a user may send a recipe to the computing device 520 for implementation by the assembly line grow pod 100. Another example may include the assembly line grow pod 100 sending notifications to a user of the user computing device 554.

Similarly, the remote computing device 552 may include a server, personal computer, tablet, mobile device, etc. and may be utilized for machine to machine communications. As an example, if the assembly line grow pod 100 determines a type of seed being used (and/or other information, such as ambient conditions), the computing device 520 may communicate with the remote computing device 552 to retrieve a previously stored recipe for those conditions. As such, some embodiments may utilize an application program interface (API) to facilitate this or other computer-to-computer communications.

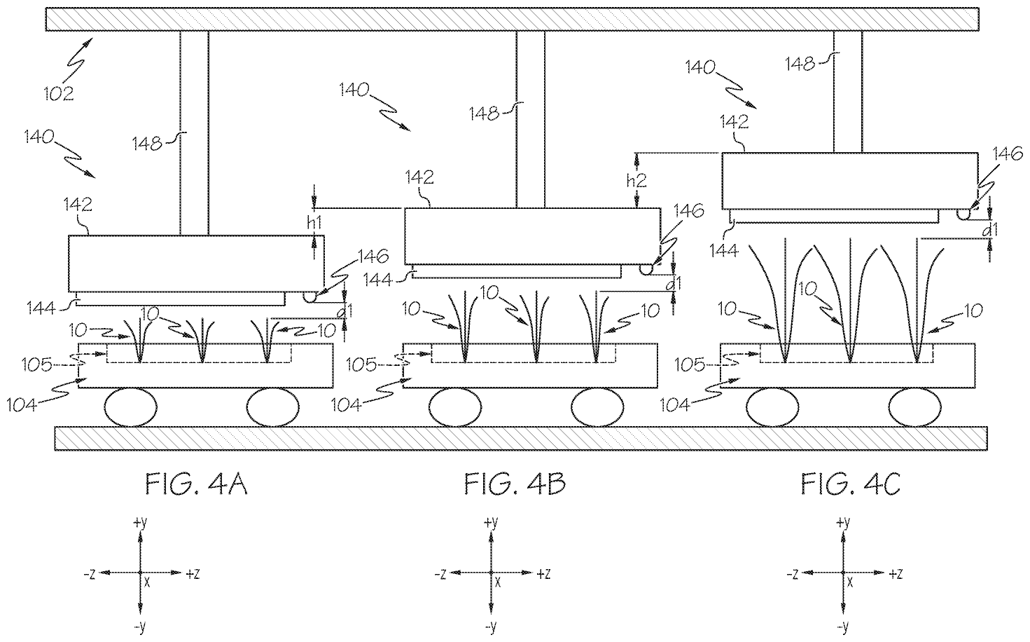

Referring to FIGS. 4A-4C, the progression of a cart 104 along the track 102 is schematically depicted. Referring initially to FIG. 4A, the movable fixture 142 of the lighting system 140 is positioned over a cart 104 including plant matter 10 at an initial stage of growth. The distance sensor 146 detects a distance between the distance sensor 146 (and accordingly the movable fixture 142) and the plant matter 10 positioned within the cart 104. In the embodiment depicted in FIG. 4A, the distance sensor 146 (and accordingly the movable fixture 142) is spaced apart from the plant matter 10 within the cart 104 by a distance “d1.” In embodiments, the distance d1 is a configurable threshold that may be selected based on the development of the plant matter 10, the type of plant matter 10, the wavelength of electromagnetic energy emitted by the one or more electromagnetic sources 144, and/or other features. In embodiments, the distance d1 may be static, and a recipe associated with the plant matter 10 may call for the distance d1 to remain constant throughout the growth cycle of the plant matter 10. In other embodiments, the distance d1 may be dynamic, and a recipe associated with the plant matter 10 may call for the distance d1 to change during the growth cycle of the plant matter 10. For example, the distance d1 may be comparatively small at initial stages of growth, and may be comparatively large at later stages in the growing process.

Furthermore, in some embodiments, the distance d1 may be selected based on a recipe associated with the plant matter 10. The recipe may call for a particular intensity and/or wavelength of electromagnetic energy emitted by the one or more electromagnetic sources 144. As such, the distance d1 may be selected based on the intensity of electromagnetic energy, the wavelength of electromagnetic energy, and/or by an amount of photons emitted by the one or more electromagnetic sources 144.

Referring to FIG. 4B, as the plant matter 10 grows, a height of the plant matter 10 as evaluated in the +y-direction as depicted, may increase. As the height of the plant matter 10 increases, the plant matter 10 generally grows closer to the movable fixture 142 in the vertical direction (e.g., in the +y-direction as depicted). The distance sensor 146 detects the distance between the plant matter 10 and the distance sensor 146 as the plant matter 10 grows closer to the movable fixture 142. Upon detecting that the plant matter 10 is within a configurable threshold of the distance sensor 146 (and accordingly the movable fixture 142), the actuator 148 moves the movable fixture 142 upward in the vertical direction (e.g., in the +y-direction as depicted) to maintain the distance d1 between the distance sensor 146 and the plant matter 10. In the embodiment depicted in FIGS. 4A and 4B, the actuator 148 moves the movable fixture 142 upward by a height “h1” evaluated in the vertical direction (e.g., in the +y-direction as depicted). The height h1 may generally correspond to the growth of the plant matter 10 evaluated in the vertical direction between FIG. 4A and FIG. 4B.

Referring to FIG. 4C, as the plant matter 10 continues to grow, the height of the plant matter 10 as evaluated in the +y-direction, continues to increase. As the height of the plant matter 10 increases, the plant matter 10 continues to grow closer to the movable fixture 142 in the vertical direction. Upon the distance sensor 146 detecting that the plant matter 10 is within a configurable threshold of the movable fixture 142, the actuator 148 again moves the movable fixture 142 upward in the vertical direction (e.g., in the +y-direction as depicted) to maintain the distance d1 between the distance sensor 146 and the plant matter 10. In the embodiment depicted in FIGS. 4B and 4C, the actuator 148 moves the movable fixture 142 upward a height “h2” evaluated in the vertical direction (e.g., in the +y-direction as depicted). The height h2 may generally correspond to the growth of the plant matter 10 evaluated in the vertical direction between FIG. 4B and FIG. 4C.

By moving the movable fixture 142 upward in the vertical direction (e.g., in the +y-direction as depicted) as the plant matter 10 grows upward in the vertical direction, the actuator 148 may maintain a constant or nearly constant distance between the plant matter 10 and the one or more electromagnetic sources 144 positioned within the movable fixture 142. By maintaining a constant or nearly constant distance between the plant matter 10 and the one or more electromagnetic sources 144, the intensity of electromagnetic energy reaching the plant matter 10 from the one or more electromagnetic sources 144 may be more consistent as compared to conventional configurations in which electromagnetic sources are not movable in the vertical direction.

For example and without being bound by theory, as electromagnetic energy propagates outward from an electromagnetic source, the electromagnetic energy may generally dissipate, such that an intensity of the electromagnetic energy and/or an amount of photons is greater at positions closer to the electromagnetic source as compared to positions further away from the electromagnetic source. In conventional configurations in which electromagnetic sources are not movable in the vertical direction, the electromagnetic sources may generally be spaced apart from the plant matter by a distance that is great enough to accommodate fully grown plant matter, such that the plant matter does not strike the electromagnetic sources as the plant matter moves below the electromagnetic sources on the carts. In some configurations, multiple types of plant matter may be grown within a controlled environment, each of the different types of plant matter having a different height when fully grown. Accordingly, in some conventional configurations the electromagnetic sources may generally be spaced apart from the plant matter by a distance that is great enough to accommodate fully grown plant matter of the largest plant matter to be grown within the controlled environment.

As such, the plant matter may be spaced apart from the electromagnetic source by a large distance at initial stages of growth in some conventional configurations, as compared to later stages of growth as the plant matter grows in the vertical direction. Consequently, the plant matter may receive a comparatively low intensity of electromagnetic energy from the electromagnetic sources at initial stages of growth, and may receive comparatively higher intensities at later stages of growth when the plant matter is positioned closer to the electromagnetic sources. The uneven application of electromagnetic energy to the plant matter at different stages of growth may limit output of the plant matter and may slow the growing process. By contrast, by maintaining a constant or nearly constant distance between the distance sensor 146 (and accordingly the one or more electromagnetic sources 144) and the plant matter 10 through vertical movement of the movable fixture 142, the lighting system 140 of the present disclosure may provide a consistent intensity of electromagnetic energy to the plant matter 10.

Moreover, by moving the one or more electromagnetic sources 144 with respect to the plant matter 10 in the vertical direction, electromagnetic energy may be provided to the plant matter at a reduced energy cost as compared to conventional configurations. For example and as described above, as electromagnetic energy propagates outward from an electromagnetic source, the electromagnetic energy may generally dissipate. Accordingly, in conventional configurations having an electromagnetic source that is fixed in the vertical direction, comparatively high amounts of electromagnetic energy may be required to compensate for dissipation, particularly at early stages of growth of the plant matter 10. In particular, at early stages of growth of the plant matter 10, the plant matter 10 may be positioned distal from the electromagnetic source. Accordingly, to receive a desired intensity of electromagnetic energy and/or a desired amount of photons at the plant matter 10, comparatively high amounts of electromagnetic energy may be required from the electromagnetic source to compensate for dissipation of electromagnetic energy between the electromagnetic source and the plant matter 10.

However, by including one or more electromagnetic sources 144 that are movable in the vertical direction as described above, the one or more electromagnetic sources 144 may be positioned proximate to the plant matter 10 in the vertical direction at all stages of plant growth. By positioning the one or more electromagnetic sources 144 proximate to the plant matter 10 in the vertical direction, loss of electromagnetic energy due to dissipation may be reduced. By reducing the loss of electromagnetic energy between the one or more electromagnetic sources 144 and the plant matter 10, comparatively less electromagnetic energy may be required from the one or more electromagnetic sources 144 to receive the desired intensity of electromagnetic energy and/or the desired amount of photons at the plant matter 10. By requiring less electromagnetic energy from the one or more electromagnetic sources 144, energy consumption of the assembly line grow pod 100 may be reduced, thereby reducing operating costs and reducing the energy footprint of the assembly line grow pod 100. Furthermore in some embodiments, in operation, the one or more electromagnetic sources 144 may be moved downward in the vertical direction (e.g., toward the plant matter 10) and the amount of energy directed to the one or more electromagnetic sources 144 may be reduced to reduce the energy consumption of the assembly line grow pod 100. Conversely, in operation the one or more electromagnetic sources 144 may be moved upward in the vertical direction (e.g., away from the plant matter 10) and the amount of energy directed to the one or more electromagnetic sources 144 may be increased.

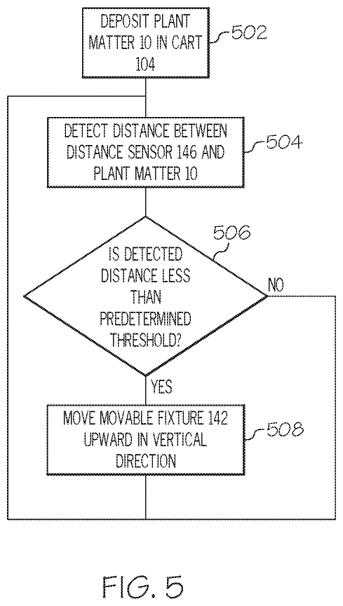

Referring collectively to FIGS. 2 and 5, an example method for growing plant matter 10 within the assembly line grow pod 100 is schematically depicted. At block 502, plant matter 10 is deposited within the cart 104. At block 504, the distance sensor 146 detects a distance between the distance sensor 146 and the plant matter 10 positioned within the cart 104. Proceeding to block 506, if the detected distance is less than a configurable threshold, then at block 508, the movable fixture 142 is moved upward in the vertical direction. If the detected distance is not less than the configurable threshold, then the system (e.g., the master controller 106) returns to block 504 and continues to detect the distance between the distance sensor 146 and the plant matter 10.

It should be understood that blocks 502-508 may be performed by a suitable computing device, such as the computing device 520 (FIG. 3) of the master controller 106, the remote computing device 552 (FIG. 3), and/or the user computing device 554 (FIG. 3). For example, at block 504, the master controller 106 (FIG. 1) may receive a signal from the distance sensor 146 indicative of the distance between the plant matter 10 and the distance sensor 146. Further at block 508, in response to determining that the detected distance between the distance sensor 146 and the plant matter 10 is less than the configurable threshold, the master controller 106 (FIG. 1) may direct the actuator 148 to move the movable fixture 142 upward in the vertical direction.

In embodiments, the configurable threshold may include any distance appropriate to provide adequate electromagnetic energy from the one or more electromagnetic sources 144 to the plant matter 10. For example and without limitation, in one embodiment the configurable threshold may be any distance greater than zero. In some embodiments, the configurable threshold may be specific to a type of plant matter. For example, in some embodiments a first type of plant matter may have a first configurable threshold, and a second type of plant matter may have a second configurable threshold that is different than the first configurable threshold. The first configurable threshold and the second configurable threshold may be particular to the first type of plant matter and the second type of plant matter, respectively, and may generally correlate to a desired intensity of electromagnetic energy to facilitate growth of the first type of plant matter and the second type of plant matter, respectively. In some embodiments, the configurable threshold may be a configurable range of distances evaluated between the distance sensor 146 and the plant matter 10.

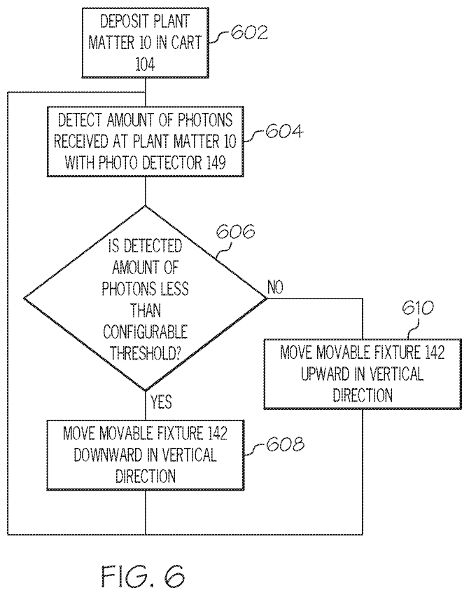

Referring collectively to FIGS. 2 and 6, another example method for growing plant matter 10 within the assembly line grow pod 100 is schematically depicted. At block 602, plant matter 10 is deposited within the cart 104. At block 604, the photo detector 149 detects an amount of photons received at the plant matter 10 positioned within the cart 104. Proceeding to block 606, if the detected amount of photons is less than a configurable threshold, then at block 608, the movable fixture 142 is moved downward in the vertical direction. If the detected amount of photons is not less than the configurable threshold, then at block 610, the movable fixture 142 is moved upward in the vertical direction. Proceeding from blocks 608 or 610, the system (e.g., the master controller 106) returns to block 604 and continues to detect the amount of photons received at the plant matter 10.

It should be understood that blocks 602-610 may be performed by a suitable computing device, such as the computing device 520 (FIG. 3) of the master controller 106, the remote computing device 552 (FIG. 3), and/or the user computing device 554 (FIG. 3). For example, at block 604, the master controller 106 (FIG. 1) may receive a signal from the photo detector 149 indicative of the amount of photons received at the plant matter 10. Further at block 608, in response to determining that the detected amount of photons is less than the configurable threshold, the master controller 106 (FIG. 1) may direct the actuator 148 to move the movable fixture 142 downward in the vertical direction. Likewise, at block 610, in response to determining that the detected amount of photons is not less than the configurable threshold, the master controller 106 (FIG. 1) may direct the actuator 148 to move the movable fixture 142 upward in the vertical direction.

In embodiments, the configurable threshold may include an amount of photons adequate to facilitate growth of plant matter 10. For example, in some embodiments a first type of plant matter may have a first configurable threshold, and a second type of plant matter may have a second configurable threshold that is different than the first configurable threshold. The first configurable threshold and the second configurable threshold may be particular to the first type of plant matter and the second type of plant matter, respectively, and may generally correlate to a desired intensity of electromagnetic energy to facilitate growth of the first type of plant matter and the second type of plant matter, respectively. In some embodiments, the configurable threshold may be a configurable range of photons.

Accordingly, it should now be understood that embodiments disclosed herein are directed to assembly line grow pods including a lighting system. In embodiments, the lighting system includes one or more electromagnetic sources positioned within a movable fixture. In some embodiments, the movable fixture is movable in the vertical direction to adjust the amount of photons received by plant matter positioned below the one or more electromagnetic sources. In some embodiments, the movable fixture is movable in the vertical direction such that the one or more electromagnetic sources may be kept at a constant or nearly constant distance above plant matter positioned within a cart underneath the lighting system. By keeping the one or more electromagnetic sources at a constant or nearly constant distance above the plant matter, a consistent intensity of electromagnetic energy may be provided to the plant matter, which may assist in facilitating growth of the plant matter.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein. It should also be understood that the embodiments described herein are merely exemplary and are not intended to limit the scope of this disclosure.

What is claimed is:

1. A lighting system for an assembly line grow pod comprises:
a fixture;
an actuator coupled to the fixture;
one or more electromagnetic sources positioned at least partially within the fixture;
a distance sensor; and
a controller communicatively coupled to the actuator and the distance sensor, the controller comprising a processor and a computer readable and executable instruction set, which when executed, causes the processor to:
receive a signal from the distance sensor indicative of a detected distance between the distance sensor and plant matter positioned below the one or more electromagnetic sources;
determine whether the detected distance is less than a configurable threshold; and
in response to determining that the detected distance is less than the configurable threshold, direct the actuator to move the fixture upward in a vertical direction.

2. The lighting system of claim 1, wherein the configurable threshold is constant throughout a growth cycle of the plant matter.

3. The lighting system of claim 1, wherein the configurable threshold is different at different stages of the growth cycle of the plant matter.

4. The lighting system of claim 1, further comprising a photo detector communicatively coupled to the controller, wherein the executable instruction set, when executed, further causes the processor to:
receive a signal from the photo detector indicative of a detected amount of photons received at the plant matter positioned below the one or more electromagnetic sources;
determine whether the detected amount of photons is within a configurable range of photons;
in response to determining that the detected amount of photons is not within the configurable range of photons, direct the actuator to move the fixture in the vertical direction.

5. The lighting system of claim 4, wherein in response to determining that the detected amount of photons is less than the configurable range of photons, the executable instruction set, when executed, causes the processor to direct the actuator to move the fixture downward in the vertical direction.

6. The lighting system of claim 5, wherein in response to determining that the detected amount of photons is greater than the configurable range of photons, the executable instruction set, when executed, causes the processor to direct the actuator to move the fixture upward in the vertical direction.

7. A method for managing plant growth within an assembly line grow pod, the method comprising:
detecting at least one of:
a distance between one or more electromagnetic sources and plant matter positioned below the one or more electromagnetic sources; and
an amount of photons received at the plant matter; and
moving the one or more electromagnetic sources in a vertical direction with respect to the plant matter based at least in part on at least one of the detected distance between the one or more electromagnetic sources and the plant matter and the detected amount of photons received at the plant matter.

8. The method of claim 7, wherein the moving the one or more electromagnetic sources in the vertical direction is based at least in part on the detected distance between the one or more electromagnetic sources and the plant matter.

9. The method of claim 8, wherein moving the one or more electromagnetic sources in the vertical direction comprises moving the one or more electromagnetic sources upward in the vertical direction in response to determining that the detected distance between the one or more electromagnetic sources and the plant matter is less than a configurable threshold.

10. The method of claim 7, wherein moving the one or more electromagnetic sources in the vertical direction is based at least in part on the detected amount of photons received at the plant matter.

11. The method of claim 10, wherein moving the one or more electromagnetic sources in the vertical direction comprises moving the one or more electromagnetic sources upward in the vertical direction in response to determining that the detected amount of photons received at the plant matter is above a configurable threshold.

12. The method of claim 10, wherein moving the one or more electromagnetic sources in the vertical direction comprises moving the one or more electromagnetic sources downward in the vertical direction in response to determining that the detected amount of photons received at the plant matter is below a configurable threshold.

13. The method of claim 7, further comprising moving the one or more electromagnetic sources downward in the vertical direction and reducing an amount of energy directed to the one or more electromagnetic sources.

14. An assembly line grow pod comprising:
a cart engaged with a track;
a fixture positioned above the track in a vertical direction;
an actuator coupled to the fixture;
one or more electromagnetic sources positioned at least partially within the fixture;
at least one of a distance sensor and a photo detector; and
a controller communicatively coupled to the actuator and the at least one of the distance sensor and the photo detector, the controller comprising a processor and a computer readable and executable instruction set, which when executed, causes the processor to:
receive a signal from at least one of:
the distance sensor indicative of a detected distance between the one or more electromagnetic sources and plant matter positioned in the cart; and
the photo detector indicative of a detected amount of photons received by the plant matter positioned within the cart; and
direct the actuator to move the fixture in the vertical direction with respect to the cart based at least in part on at least one of the detected distance between the one or more electromagnetic sources and the plant matter and the detected amount of photons received at the plant matter.

15. The assembly line grow pod of claim 14, wherein the executable instruction set, when executed, causes the processor to direct the actuator to move the fixture in the vertical direction based at least in part on the detected distance between the one or more electromagnetic sources and the plant matter.

16. The assembly line grow pod of claim 15, wherein the executable instruction set, when executed, further causes the processor to:
determine whether the detected distance between the one or more electromagnetic sources and the plant matter is less than a configurable threshold; and
direct the actuator to move the fixture in upward in the vertical direction in response to determining that the detected distance between the one or more electromagnetic sources and the plant matter is less than the configurable threshold.

17. The assembly line grow pod of claim 14, wherein the executable instruction set, when executed, causes the processor to direct the actuator to move the fixture in the vertical direction based at least in part on at least in part on the detected amount of photons received at the plant matter.

18. The assembly line grow pod of claim 17, wherein the executable instruction set, when executed, further causes the processor to:
determine whether the detected amount of photons received at the plant matter is above a configurable threshold; and
direct the actuator to move the fixture in upward in the vertical direction in response to determining that the detected amount of photons received at the plant matter is above the configurable threshold.

19. The assembly line grow pod of claim 17, wherein the executable instruction set, when executed, further causes the processor to:
determine whether the detected amount of photons received at the plant matter is below a configurable threshold; and
direct the actuator to move the fixture downward in the vertical direction in response to determining that the detected amount of photons received at the plant matter is below the configurable threshold.

20. The assembly line grow pod of claim 14, wherein the track comprises a first level and a second level positioned above the first level, wherein the cart is positioned on the first level and the actuator is coupled to the second level.
